(19) United States
(12) Patent Application Publication
(10) Pub. No.: US 2009/0014422 A1
(43) Pub. Date: Jan. 15, 2009

(54) Device and Method for Welding Workpieces

(75) Inventors: Ernst Miklos, Kirchheim (DE); Dieter Rebhan, Geretstried (DE); Christoph Matz, Unterschleissheim (DE)

Correspondence Address: WILSON SONSINI GOODRICH & ROSATI, 650 PAGE MILL ROAD, PALO ALTO, CA, 94304-1050, US

(73) Assignee: Linde AG

(21) Appl. No.: 12/171,114

(22) Filed: Jul. 10, 2008

(30) Foreign Application Priority Data
Jul. 10, 2007 (DE) DE 102007032067.3
Nov. 21, 2007 (EP) EP 07 022 615.4

(51) Int. Cl. B23K 35/38

(52) U.S. Cl. 219/75

(57) ABSTRACT

According to the invention a welding device for welding workpieces is provided. The welding device comprises a welding means for making a welding seam on workpieces and a cleaning nozzle in order to emit a cryogenic medium onto the surfaces of the workpieces in the area of their welding seam to be formed. The distance between the welding means and the nozzles is at least 5 cm.

### CROSS-REFERENCE

This application claims the benefit of DE 10 2007 032 067.3, filed Jul. 10, 2007, which claims priority to EP 07 022 615.4, filed Nov. 21, 2007, all of which are incorporated herein by reference.

### BACKGROUND OF THE INVENTION

The present invention relates to a device and a method for welding workpieces.

During welding components are permanently connected with each other by applying heat or pressure with or without welding additives. Welding methods working with heat are e.g. forge welding, gas welding, manual arc welding, resistance welding, laser beam welding, aluminothermic welding and electron beam welding.

Metallic workpieces, plastic parts and glass parts can be permanently and firmly connected with each other by means of the known welding methods.

Deep-drawn and/or high-pressure formed metallic components are frequently further processed by means of welding methods.

During deep-drawing a sheet metal blank is formed under combined tensile and compressive conditions to a unilaterally open hollow body or a pre-drawn hollow body is formed under combined tensile and compressive conditions to a hollow body with a lesser cross-section and without deliberate change in the sheet thickness.

In order to prevent drawing defects, in particular the tearing of the material, even in the case of higher true strains, drawing agents, e.g. fats, oils, soaps and coatings are used. Due to this, the signs of wear on the tool are reduced and the surface condition of the workpiece is improved. After the forming process these drawing agents leave behind residues on the surface. For the welding of the formed parts they must be freed from the drawing agent residues, since the drawing agents substances do not permit a high-quality welding. The removal of the drawing agents by means of washing or pickling is very expensive and harmful to the environment, since the entire component must be cleaned.

It may happen during high-pressure forming that the drawing agents are pressed deep into the aluminum surface so that a complete removal by means of washing or pickling is no longer possible. This results in welding seam defects in the further processing, e.g. during joining by means of welding.

The cleaning with CO₂ pellets and CO₂ jet is known for surface cleaning. The temperature of such cryogenic media is from −50° C. to −196° C.

EP 1 356 890 A1 reveals a partial processing and/or welding method which is assisted by a cryogenic jet. A welding device is used in the process, in whose direct neighborhood one or several nozzles for emitting a cryogenic medium are disposed. Liquid nitrogen or solid CO₂ can be used as cryogenic medium. Due to the cryogenic medium flowing out of the nozzle(s) liquid metal spatter formed during welding are very rapidly cooled and solidified. The liquid metal spatter does not adhere to the workpiece surface and does not contaminate it. Due to this, a finishing of the workpieces is superfluous. Since the welding spatter is to be cooled, the cryogenic medium must be supplied in the direct neighborhood to the electric arc. This has a considerable influence on the electric arc and considerably impairs the welding process.

### OBJECTS OF THE INVENTION

The object of the invention is the providing of a method and a device with which it is possible to remove drawing agent residues on a workpiece surface without having to clean the entire workpiece. Moreover, residues are to be removed which cannot be removed by pickling or washing.

The object is attained with a device with the features of claim 1 and a method with the features of claim 10.

Advantageous further developments are indicated in the respective sub-claims.

### SUMMARY OF THE INVENTION

According to the invention a welding device for welding workpieces is provided. The welding device comprises a welding means for making a welding seam on workpieces and a nozzle for emitting a cryogenic medium onto the surfaces of the workpieces in the area of their welding seam to be formed. The nozzle is located at a distance of at least 5 cm from the welding means.

Workpiece surfaces can be cleaned and cooled with the device according to the invention prior to the welding procedure.

Several advantageous effects result from the bombardment of the workpiece surface with the cryogenic medium. In addition to the mechanical removal of separating and/or drawing agent residues by means of abrasion, which takes place first, a strong point-wise cooling of the area subjected to the jets results, which results in advantageous effects for the subsequent welding process. The area surrounding the edges to be welded is completely freed from impurities, due to which an optimum welding seam can be made. Due to the cooling of the area surrounding the edges to be welded, if possible directly prior to the welding process, the quality of the welding seam is additionally improved and the distortion on the workpiece is minimized, due to which subsequent dressing work can be reduced and/or partly completely omitted. Moreover, the cryogenic medium transitions into the gaseous state upon impact on the surface under atmospheric pressure, an approx. 600-fold increase in the volume of the cryogenic medium taking place. The gas eddies formed due to this remove the supercooled and embrittled separating and/or drawing agent residues without damaging the workpiece surface.

The welding device according to the invention is above all designed for the welding of metallic workpieces. It is, however, possible within the framework of the present invention to provide welding means for welding workpieces from plastic material or glass. These workpieces, as well, can be cleaned with a cryogenic medium. Separating agents and skins of the injection molded plastic material, which result from the injection operation, can above all be removed in the case of plastic materials. Suitable welding processes for welding plastic materials are hot gas welding, heated tool welding, friction welding, ultrasonic welding, high-frequency welding and laser welding.

Due to the fact that a distance of at least 5 cm is provided between the nozzle and the welding means the welding process is not obstructed, in particular if it is implemented by means of an electric arc. In the case of smaller distances the electric arc which, being plasma, is itself gaseous would be considerably impaired by the cryogenic medium supplied via the nozzle. The distance of at least 5 cm means that the welding agent (electric arc, laser, hot gas, etc.) impinges on the workpieces to be welded with a distance of at least 5 cm to the center of the jet of cryogenic medium. In the case of a smaller distance the effect of the welding agent is impaired and, also, a reduced cleaning effect or no cleaning effect at all is achieved. Moreover, it is not expedient to directly cool the melt of the workpieces produced with the welding agent. This would negatively affect the quality of the welding.

The device according to the invention can be briefly summarized as follows:

According to the invention a welding device for welding metallic workpieces is provided. The welding device comprises a welding means for making a welding seam on workpieces and a nozzle in order to emit a cryogenic medium on the surfaces of workpieces in the area of their welding seam to be formed.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1: schematically shows a first example of embodiment of a welding device with a robot for handling a welding means and a CO₂ nozzle; and

FIG. 2: schematically shows a second example of embodiment of a welding device with a CO₂ nozzle disposed in front of the welding means.

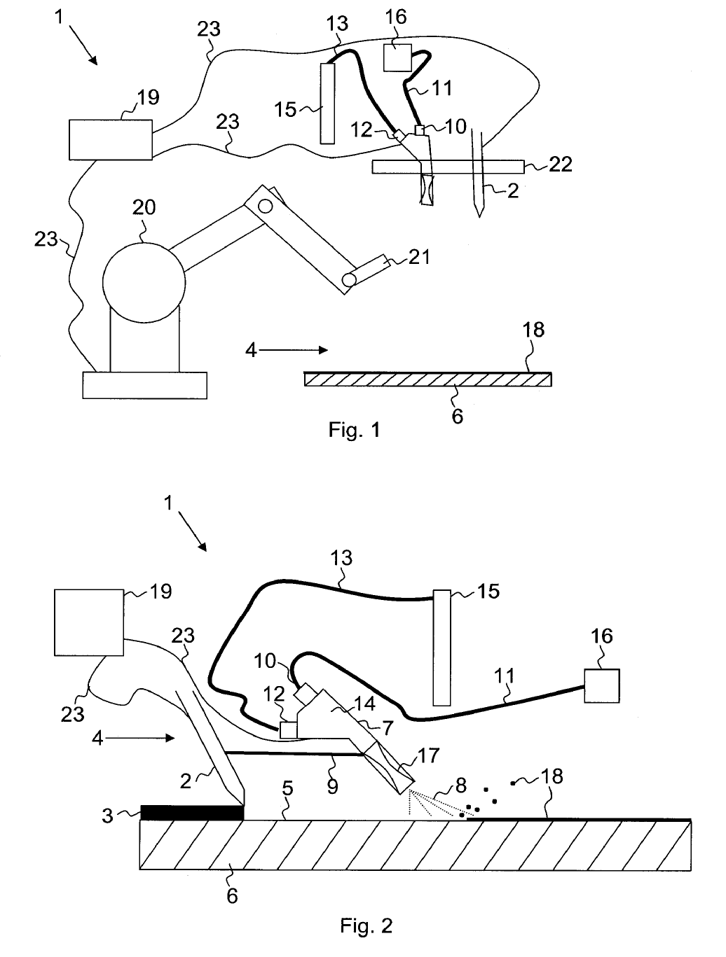

### DETAILED DESCRIPTION OF THE INVENTION

The welding device 1 according to the invention comprises according to a first example of embodiment a robot 20 with a change-over system 21. The change-over system 21 is a retainer at the end of the robot arm in order to retain various tools. A welding means 2 and a CO₂ nozzle 7 are provided as tools, which are retained by the change-over system 21 of the robot 10. The tools 2, 7 are disposed in a separate magazine 22.

The welding device 1 comprises a control means 19 for activating the robot 20, the change-over system 21 and the tools 2, 7. The control means 19 is connected with the robot 20, the change-over system 21 and the tools 2, 7 via data lines 23.

The welding means 2 may e.g. be designed as a means for inert gas shielded arc welding.

The CO₂ nozzle 7 and/or gun emits a cryogenic mixture 8 of CO₂ and compressed air and/or a cryogenic medium 8. The cryogenic medium is in particular a mixture of carbon dioxide snow and compressed air. A compressed air line 11 is connected to the CO₂ nozzle 7 via a compressed air valve 10 and a CO₂ line 13 is connected to the CO₂ nozzle 7 via a CO₂ valve 12. Both valves 10, 12 open into a mixing chamber 14 of the CO₂ nozzle 7. A cryogenic mixture 8 of CO₂ and compressed air is generated from liquid CO₂ and/or cold CO₂ gas and/or CO₂ pellets and/or CO₂ snow and compressed air in the mixing chamber 14.

The compressed air line 11 is connected with a compressed air supply 16. The CO₂ line 13 is connected to a CO₂ reservoir 15.

A Laval nozzle 17 is disposed downstream of the mixing chamber 14. The cryogenic mixture 8 of CO₂ and compressed air is accelerated to approximately the speed of sound by means of the Laval nozzle 17.

The forming of the welding seam 4 and the amount of the emitted cryogenic mixture of CO₂ and compressed air can be controlled with the control means 19. The movements of the robot 20 are controlled by means of the control means 19.

In the following the use of the device 1 described above will be described.

The control means 19 controls the entire sequence of operations of the welding device 1 by accordingly activating the robot 20, the change-over system 21, the CO₂ nozzle 7 and the welding means 2.

The change-over system 21 of the robot 20 takes the CO₂ nozzle 7 from the magazine 22 and accordingly positions it over a workpiece surface 5 of a workpiece 6, which is to be cleaned.

The CO₂ valve 12 and the compressed air valve 10 at the CO₂ nozzle 7 are activated via the control means 19. Compressed air and cryogenic CO₂ flow into the mixing chamber 14 of the CO₂ nozzle 7. The cryogenic mixture 8 of CO₂ and compressed air is formed in the mixing chamber 14. The cryogenic mixture of CO₂ and compressed air is accelerated to almost the speed of sound when it flows through the Laval nozzle 17.

When the cryogenic mixture 8 of CO₂ and compressed air exits the Laval nozzle 17 and/or the CO₂ nozzle 7, it impacts on the drawing agent 18 adhering to a workpiece surface 5 and removes it so that a clean workpiece surface 5 is made available on which a high-quality welding seam 3 can be made. The robot 20 moves the CO₂ nozzle 7 in the direction of welding 4.

Moreover, the area in which the welding seam 3 is formed is cooled, which results in a lesser distortion of the workpiece 6.

When the entire area to be cleaned was cleaned, the robot 20 and/or the change-over system 21 deposits the CO₂ nozzle 7 again in the magazine 22 and takes the welding means 2 from the magazine 22 and positions it over the cleaned and cooled area of the workpiece surface 5. Then, the welding means 2 is activated by the control means 19 and begins with the making of a welding seam 3 in the direction of welding 4 on the workpiece surface 5. For instance, the workpiece is a deep-drawn aluminum component.

Moreover, it may be provided to finish the welding seam 3 with the CO₂ nozzle 7 in order to clean it and/or minimize distortion.

In a further example of embodiment the welding device 1 according to the invention comprises a welding means 2. The welding means 2 may e.g. be designed as a means for inert gas shielded arc welding.

The welding means 2 generates a welding seam 3 in the welding direction 4 on a workpiece surface 5 of a workpiece 6. The workpiece 6 is e.g. a deep-drawn aluminum component.

A CO₂ nozzle 7 for emitting a cryogenic mixture 8 of CO₂ and compressed air is disposed before the welding means 2 in the direction of welding 4. The CO₂ nozzle 7 is connected with the welding means 2 via a connection element 9. The distance between the welding means 2 and the CO₂ nozzle 7 is between 5 cm and 20 cm and preferably between 5 cm and 10 cm.

A compressed air line 11 for supplying compressed air is connected to the CO₂ nozzle 7 via a compressed air valve 10 and a line 13 for supplying cryogenic CO₂ is connected to the CO₂ nozzle 7 via a CO₂ valve 12.

Both connections open into a mixing chamber 14.

Cryogenic CO₂ is introduced into the mixing chamber 14 of the CO₂ nozzle 7 from a CO₂ reservoir 15, e.g. from a CO₂ bottle, via the CO₂ line 13. Compressed air from a compressed air supply source 16 is made available, which is introduced into the mixing chamber 14 via compressed air line 11. The cryogenic mixture 8 of CO₂ and compressed air is formed from the cryogenic CO₂ and compressed air in the mixing chamber 14.

A Laval nozzle 17 is disposed downstream of the mixing chamber 14. The cryogenic mixture 8 of CO₂ and compressed air is accelerated to approximately the speed of sound by means of the Laval nozzle 17 and subsequently directed to the workpiece surface 5.

The area on the workpiece surface 5 on which the welding seam 3 is made is freed from drawing agent 18 adhering to the workpiece surface 5 by the emitted cryogenic mixture 8 of CO₂ and compressed air.

The welding means 2 and the CO₂ nozzle 7 are both connected with a control means 19. The thickness of the welding seam 3 and the amount of the emitted cryogenic mixture 8 of CO₂ and compressed air can e.g. be controlled via the control means 19.

In a further example of embodiment of the device according to the invention a second CO₂ nozzle 7 is disposed in the welding direction 4 behind the welding means 2 in order to remove surface coatings following the welding process and to cool the welding area in order to prevent distortions in the workpiece. Due to this, the dressing of the workpiece 6 after the joining can be avoided.

The welding means 2 can also be designed as a device for forge welding, gas welding, manual arc welding, resistance welding, laser beam welding, aluminothermic welding, friction welding and electron beam welding.

The device according to the invention can also be used in automated manufacturing e.g. in connection with a robot.

The workpiece may consist of any weldable metal.

The device according to the invention may also be designed as a hand-held device.

The device according to the invention may also only be designed as a CO₂ nozzle as an add-on unit for an existing welding means.

The use of the device described above for the CO₂ cleaning during the joining of metals will be explained in the following.

The CO₂ valve 12 and the compressed air valve 10 at the CO₂ nozzle 7 are opened via the control means 19. Compressed air and liquid CO₂ flow into the mixing chamber 14 of the CO₂ nozzle 7. A cryogenic mixture 8 of CO₂ and compressed air is formed in the mixing chamber 14. The cryogenic mixture 8 of CO₂ and compressed air is accelerated to approximately the speed of sound when it flows through the Laval nozzle 17.

Upon the exit from the Laval nozzle 17 the cryogenic mixture 8 of CO₂ and compressed air impacts on the drawing agent 18 adhering to the workpiece surfaces 5 and removes it so that a high-quality welding seam 3 can be made. Moreover, the area in which the welding seam 3 is formed is cooled which results in lesser distortion of the workpiece 6.

The device 1 is e.g. fully automatically moved by a robot in the direction of welding. When the welding means 2 is located above the cleaned and cooled area of the workpiece surface 5, the welding means 2 is activated by the control means 19 and begins with the making of a welding seam 3 on the workpiece surface 5.

When the welding process is completed, it may be provided to move the device according to the invention contrary to the direction of welding 4, e.g. retracing the entire extension of the welding seam 3, in order to cool the area around the welding seam 3 and the welding seam 3 itself in order to minimize the distortion and to remove surface coatings.

In particular when welding aluminum, the making of neat welding seams and a post-cleaning are of importance since the welding seams are often visible seams which must not be finished, i.e. polished or varnished.

A mixture of liquid CO₂ or CO₂ snow or CO₂ pellets or gaseous CO₂ with compressed air is in particular provided as cryogenic mixture of CO₂ and compressed air.

During the bombardment with cryogenic medium which precedes the welding process several advantageous effects are obtained. In addition to the mechanical removal of separating and/or drawing agent residues by means of abrasion, a strong point-wise cooling of the impacted area results directly prior to the welding process results. The area surrounding the edges to be welded is completely freed from impurities, whereby an optimum welding seam can be made. Due to the cooling of the area surrounding the edges to be welded the distortions at the workpiece are minimized, due to which later dressing work can partly be completely omitted. Moreover, the cryogenic agent transitions into the gaseous state when it impacts on the surface under atmospheric pressure, due to which a 600-fold increase in the volume of the cryogenic medium takes place. The gas eddies formed due to this remove the supercooled and embrittled separating and/or drawing agent residues without damaging the workpiece surface.

The invention was explained above by means of the joining of metallic workpieces. However, the invention is not restricted to the joining of metallic workpieces. It is also possible within the framework of the invention to join other materials such as plastic materials or glass and to cool and clean them in advance in the area of the joining seam by means of a cryogenic medium. Here, a distance of at least 5 cm between the joining agent (electric arc, laser beam, etc.) and the center of the jet of cryogenic medium must be observed in particular for thermal welding. Preferably, the distance is at least 8 cm and/or at least 10 cm.

### LIST OF REFERENCE NUMERALS

1. Welding device
2. Welding means
3. Welding seam
4. Welding direction
5. Workpiece surface
6. Workpiece
7. CO2 nozzle
8. Cryogenic mixture of CO2 and compressed air
9. Connecting element
10. Compressed air valve
11. Compressed air line
12. CO2 valve
13. CO2 line
14. Mixing chamber
15. CO2 reservoir
16. Compressed air supply
17. Laval nozzle
18. Drawing agent
19. Control means
20. Robot
21. Change-over system
22. Magazine
23. Data line

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A welding device for welding workpieces comprising a welding means (2) for making a welding seam (3) on workpieces (6) and a nozzle (7) in order to emit a cryogenic medium (8) onto the surfaces (5) of the workpieces (6) in the area of their welding seam to be formed, the distance between the welding means (2) and the nozzle (7) being at least 5 cm.

2. The welding device according to claim 1
wherein the welding device (1) comprises a welding robot (20).

3. The welding device according to claim 1 or claim 2,
wherein a change-over system (21) is formed on the robot (20) in order to retain a tool.

4. The welding device according to any of claims 1 to 3,
wherein the tool is a CO₂ nozzle (7).

5. The welding device according to any of claims 1 to 4,
wherein the tool is a welding means (21).

6. The welding device according to any of claims 1 to 5,
wherein the nozzle (7) for emitting the cryogenic medium (8), for cleaning, cooling and for minimizing the distortion of the workpiece (6) is disposed in front of the welding means (2) in the direction of welding (4).

7. The welding device according to any of claims 1 to 6,
wherein a second nozzle (7) for emitting the cryogenic medium (8), for cleaning, cooling and for minimizing the distortion of the workpiece (6) is disposed behind the welding means (2) in the direction of welding (4).

8. The welding device according to any of claims 1 to 7,
wherein the welding means (2) is designed as a means for gas welding, manual arc welding or laser beam welding.

9. The welding device according to any of claims 1 to 8,
wherein the distance between the welding means (2) and the nozzle (7) is between 5 cm and 20 cm and preferably between 5 cm and 10 cm.

10. A process for welding workpieces,
wherein a cryogenic medium (8) is impacted on the surfaces (5) of the workpieces (6) in the area of their welding seam to be formed in order to clean and cool this area and the workpieces are welded with each other in the cleaned area.

11. The process according to claim 10,
wherein a distance of at least 5 cm between the one welding means (2) making the welding seam and the cryogenic medium (8) is observed.

12. The process according to claim 10 or 11,
wherein the welding seam (3) made by the welding device (1) is subsequently cleaned by a second nozzle (7) and the distortion of the workpiece (6) is reduced by means of cooling.

13. The process according to any of claims 10 to 12,
wherein a cryogenic mixture of CO₂ and compressed air is emitted as the cryogenic medium (8).

14. The process according to claim 13,
wherein liquid CO₂ or CO₂ snow or CO₂ pellets or gaseous CO₂ is used in the cryogenic mixture (8) of CO₂ and compressed air.

15. The process according to any of claims 10 to 14,
wherein deep-drawn metallic components are welded, wherein the components are freed from drawing agent residues by the cryogenic medium.
